(19) United States
(12) Patent Application Publication
(10) Pub. No.: US 2005/0111087 A1
(43) Pub. Date: May 26, 2005

(54) Observation device with separate operating unit

(75) Inventors: Johannes Knoblich, Jena (DE); Thomas Serfling, Jena (DE); Tobias Kaufhold, Jena (DE)

Correspondence Address: Gerald H. Kiel, Esq.;REED SMITH LLP, 599 Lexington Avenue, New York, NY, 10022-7650, US

(73) Assignee: CARL ZEISS JENA GmbH

(21) Appl. No.: 10/993,659

(22) Filed: Nov. 19, 2004

(30) Foreign Application Priority Data
Nov. 21, 2003 (DE) 103 55 526.9

(51) Int. Cl. G02B 21/00

(52) U.S. Cl. 359/368; 359/363

(57) ABSTRACT

The invention is directed to an observation device in which a user observes objects or process flows and influences the display of the object or the flow of the process by entering operating commands and control demands. The observation device is outfitted with an operating unit which is spatially separable with respect to the rest of the components of the observation device. According to the invention, a device for displaying and presetting adjustment values relating to the device parameters and/or a device for displaying images of the object or process flow to be observed are provided at the operating unit. These display devices can preferably be constructed as a touch screen which enables an optical display of the adjusted device parameters and a graphic display of the object or process flow to be observed and makes it possible to enter operating commands and control commands by touching the display surface

### CROSS-REFERENCE TO RELATED APPLICATION

This application claims priority of German Application No. 103 54 526.9, filed Nov. 21, 2003, the complete disclosure of which is hereby incorporated by reference.

### BACKGROUND OF THE INVENTION

a) Field of the Invention

The invention is directed to an observation device in which a user observes objects or process flows and influences the display of the object or the flow of the process by entering operating commands and control demands. The observation device is outfitted with an operating unit which is spatially separable with respect to the rest of the components of the observation device.

b) Description of the Related Art

Depending on their use and particular application, observation devices, including microscopes, have a plurality of parameters which must be changed, adapted and monitored within the framework of operation and control. For example, in a conventional optical microscope or stereo microscope the adjustment of focus, changes in the scale ratio, change and selection of contrast methods and illumination methods, light regulation, displacement of the object, and the supply of operating voltage are some of the possibilities for optimizing observation. This list is not complete.

In the case of microscopes, it is conventional in the art to operate and control by means of manually actuated rotating knobs, switches, slides etc. which can be arranged at different locations on the microscope. This arrangement is frequently uncomfortable for the user because the operating controls and control elements are often arranged in ergonomically unfavorable positions. When using the microscope continuously for many hours, this is fatiguing and is therefore a noticeable drawback.

While there are also known arrangements which make it possible to operate and control an optical microscope by means of a PC or laptop, a solution of this kind is relatively wasteful with respect to material and time and is therefore not considered, in particular, for training and routine uses. Further, this kind of combination of microscope and control computer takes up a disproportionately large amount of space compared with the microscope by itself.

### OBJECT AND SUMMARY OF THE INVENTION

Therefore, it is the primary object of the invention to further develop an observation device of the type described above in such a way that a simplified and ergonomically favorable operation is made possible for the user.

According to the invention, means for displaying and presetting adjustment values with respect to the device parameters and/or means for displaying images of the object or process flow to be observed are provided at the operating unit.

These display means can preferably be constructed as a visual display or screen, particularly as a graphic display. In another construction, a touch screen can be provided which makes it possible to enter operating commands and control commands by touching the display surface.

Alternatively or in addition to this, the operating unit is outfitted with programmable buttons which serve to enter commands for different parameters depending on the determined function. Further, the operating unit is provided with a programmable joystick which is likewise constructed for entering commands.

A wireless or wire-bound connection can be considered for transmitting the operating commands and control commands from the operating unit to the rest of the device components.

In the latter case, this connection is advantageously constructed as a CAN bus connection. A device may be provided as a mechanical auxiliary device for automatically winding up or unwinding the signal line between the operating unit and the rest of the device units; this has proven useful particularly when the operating unit is moved often from place to place.

Fastening elements are preferably provided at the operating unit and at the base construction of the observation device. These fastening elements cooperate with one another in the manner of a coupling device and are used for mechanically coupling, e.g., the operating unit to the device frame of the observation device if necessary.

When the observation device is a microscope, for example, the operating unit is connected to or can be detached from the microscope body by means of the coupling device. Accordingly, the operating unit can be located on the microscope body in the rest position.

The coupling device advantageously has holding elements for a positively engaging connection of the operating unit to the microscope body. These holding elements can be realized, for example, by means of a dovetail guide which is advisably provided with stops for limiting movability in the guide direction. This prevents the observation device from being separated unintentionally when lifting or moving the observation device or microscope, for example. Apart from a dovetail guide such as this, any other type of positive engagements with mechanical elements engaging one inside the other are, of course, also possible.

Alternatively, the coupling device can be outfitted with holding elements for a frictionally engaging connection of the operating unit to the device body. For example, a surface of the device frame can be magnetized and permanent magnets can be provided on a corresponding surface of the operating unit. In order to achieve an exact fit, additional guide pins engaging in corresponding recesses at the device frame of the microscope can be provided. The permanent magnets can also be constructed as pins.

In order to move into a work position, the operating unit is brought into an ergonomically favorable position for the user by detaching the coupling device from the device body. The operating unit can preferably be detached from the device body without technical auxiliary devices or tools.

When actuating operating controls that are arranged at the operating unit, the control signals are conveyed from the operating unit to the rest of the device components, which can be carried out in a wireless manner by radio or via an infrared interface or by means of wires as was already mentioned.

Wireless transmission is preferably reserved for reproducing signals for light regulation, specimen adjustment, focusing, and changing between operating mode and standby mode. For other signals such as switching the device on and off, a wire-bound connection by means of cables is indispensable.

A plug connection with electrical contacts which also possibly includes a data bus and accordingly enables data transfer between the device components and the operating unit can advantageously be provided particularly for purposes of supplying auxiliary power to the operating unit. The plug connection is constructed as a CAN bus connection in a particularly preferred manner.

Compared to coupling a conventional PC to a microscope body, the solution according to the invention has the important advantage that the microscope can be operated more favorably with respect to ergonomics. Further, there is also the advantage of compactness due to the possibility of arranging the operating unit on the microscope body at least at times.

When the operating unit is outfitted with programmable buttons which serve to call up adjusted device parameters, the user can immediately read off these parameters at the display device which is likewise associated with the operating unit, draw conclusions from the read off device parameters concerning the device parameters to be changed, and preset these device parameters for purposes of adjustment at the microscope by means of the command buttons at the operating unit.

Of course, the input elements at the operating unit need not be constructed as buttons but can also be constructed in any other form suitable for entering commands. For example, a scroll wheel can be provided for changing the display on the operating unit between different device parameters.

In a particular construction, the operating unit can be outfitted with a device for the output of acoustic signals whose volume or frequency depends upon device parameters that are adjusted or are to be preset.

The invention will be described more fully in the following with reference to embodiment examples.

### BRIEF DESCRIPTION OF THE DRAWINGS

In the drawings:

FIG. 1 shows a microscope body and an operating unit which are connected to one another by a coupling device;

FIG. 2 is an enlarged view of the operating unit; and

FIGS. 3 and 4 shows other possible embodiments of operating units.

### DESCRIPTION OF THE PREFERRED EMBODIMENTS

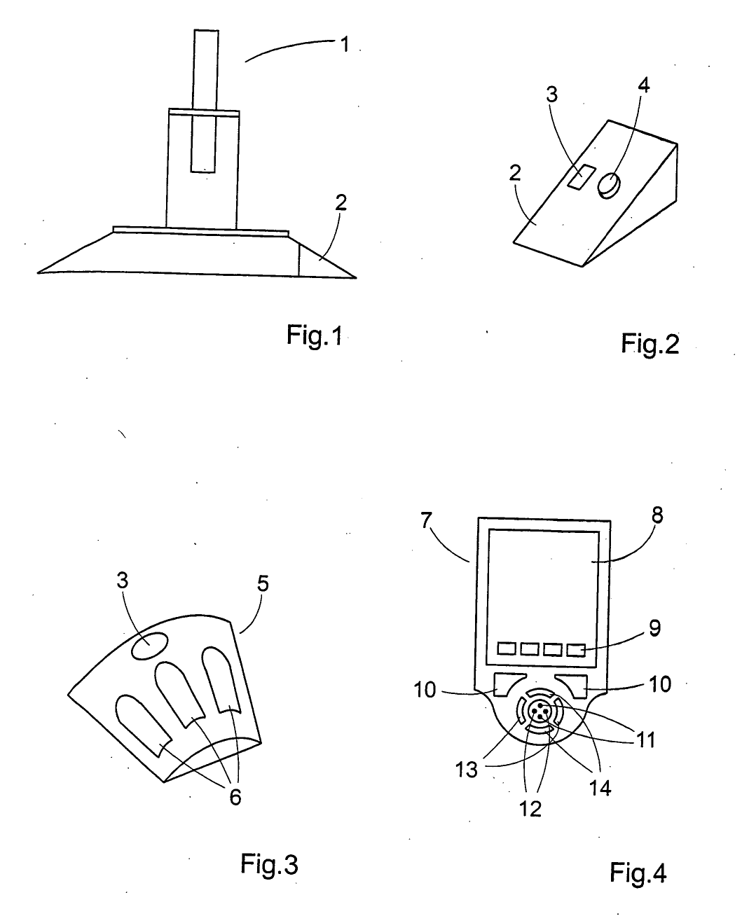

FIG. 1 shows a microscope body 1 with an operating unit 2 which is connected to the microscope body 1 by means of a coupling device (not shown in the drawing).

The operating unit 2 is shown individually in an enlarged view in FIG. 2. The signals are conveyed from the operating unit 2 to the rest of the microscope body 1 in a wireless manner in this case, for example.

Two operator controls can be seen on the operating unit 2, namely, a network switch 3 which switches between a standby mode and operating mode, and a rotating knob 4 for light regulation by which the brightness of the illumination light can be influenced particularly with transmitted light illumination.

FIG. 3 shows a first alternative to the operating unit 5 shown in FIG. 2. A network switch 3 for changing between operating mode and standby mode is also provided in this case. The buttons 6 are provided for other operating functions.

Finally, FIG. 4 shows a second alternative operating unit 7. This operating unit 7 has a touch screen 8 with touch screen buttons 9. Operating functions can be displayed on the touch screen 8 on the one hand, but the observed image can also be shown on the other hand insofar as the microscope body 1 has corresponding components for generating images.

In this case, an object or a sample can be observed on the operating unit 7 or at the touch screen 8 and observation need not be carried out through the eyepiece of the microscope body 1. Further, the operating unit 7 has specially adapted operating controls for directly presetting or influencing device functions. In addition to the input buttons 10, these are focusing buttons 11, zoom buttons 12, transmitted light regulating buttons 13 and incident light regulating buttons 14.

All of the buttons are provided in pairs because there are two directions in which the adjustments can be changed. The transmitted light regulating buttons 13 and incident light regulating buttons 14 can also be used optionally for navigation with appropriate programming. For example, the sample carrier can be moved relative to the microscope objective by means of these buttons and another section of the sample can accordingly be adjusted for observing on the touch screen 8.

While the foregoing description and drawings represent the present invention, it will be obvious to those skilled in the art that various changes may be made therein without departing from the true spirit and scope of the present invention.

Reference Numbers

1 microscope body
2 operating unit
3 network switch
4 rotating knob
5 first alternative operating unit
6 buttons
7 second alternative operating unit
8 touch screen
9 touch screen buttons
10 input buttons
11 focusing buttons
12 zoom buttons
13 transmitted light regulating buttons
14 incident light regulating buttons

1. An observation device by which a user observes objects or process flows and influences the display of an object or a process flow by entering operating commands and control demands for changing device parameters, comprising:
an operating unit which is spatially separable with respect to other components of the observation device; and
at least one of means for displaying and presetting adjustment values relating to the device parameters and means for displaying images of the object or process flow to be observed being provided at the operating unit.

2. The observation device according to claim 1, wherein a screen is provided as means for displaying the adjustment values or as means for displaying the object or process flows.

3. The observation device according to claim 2, wherein the screen is constructed as a touch screen which makes it possible to preset adjustment values by touching the display surface.

4. The observation device according to claim 1, wherein programmable buttons are provided at the operating unit for presetting adjustment values.

5. The observation device according to claim 4, wherein at least one of the buttons is provided for automatically adjusting stored or preset device parameters.

6. The observation device according to claim 1, wherein at least one programmable scroll wheel is provided at the operating unit for presetting adjustment values.

7. The observation device according to claim. 1, wherein the operating unit is provided with a programmable joystick for presetting adjustment values.

8. The observation device according to claim 1, wherein a coupling device is provided for fastening the operating unit to the rest of the body of the observation device in a positive or frictional engagement.

9. The observation device according to claim 1, wherein a wireless or wire-bound connection is provided for transmitting auxiliary power and control signals between the operating commands and the rest of the components of the observation device.

10. The observation device according to claim 9, wherein a plug connection with electrical contacts which preferably also includes a data bus and accordingly enables data transfer between the device components and the operating unit is provided between the observation device and the operating unit.

11. The observation device according to claim 9, wherein a CAN bus connection is used for transmitting operating signals and control signals.

12. The observation device according to claim 9, wherein a device for automatically winding up or unwinding the cable is provided in case of a wire-bound connection when the operating unit is moved to another location relative to the rest of the device components.

13. The observation device according to claim 1, wherein the operating unit has a device for the output of acoustic signals whose volume or frequency depends upon device parameters that are adjusted or are to be preset.

14. The observation device according to claim 1, constructed as a microscope with an operating unit that is detachably connected to the rest of the microscope components by means of a coupling device for entering operating commands and control commands for changing device parameters, wherein the operating unit has means for displaying adjustment values relating to the device parameters and/or means for displaying images of an object or process flow to be observed.
